(19) United States
(12) Patent Application Publication
(10) Pub. No.: US 2025/0171246 A1
(43) Pub. Date: May 29, 2025

(54) Battery Cell Feeder With Integrated Position Orientation Function

(71) Applicant: teamtechnik Maschinen und Anlagen GmbH, Freiberg (DE)

(72) Inventor: Dieter BREITENBÜCHER, Filderstadt (DE)

(73) Assignee: teamtechnik Maschinen und Anlagen GmbH, Freiberg (DE)

(21) Appl. No.: 18/962,040

(22) Filed: Nov. 27, 2024

(30) Foreign Application Priority Data
Nov. 29, 2023 (DE) 10 2023 133 429.8

(51) Int. Cl. B65G 47/31; B65G 15/22; B65G 15/30; B65G 41/00; H01M 10/04

(52) U.S. Cl. CPC B65G 47/31; B65G 15/22; B65G 15/30; B65G 41/001; H01M 10/0409; H01M 10/0422; B65G 2201/0217

(57) ABSTRACT

The present disclosure relates to an apparatus for transporting cylindrical components, in particular battery cells, from a start region to a target region. The apparatus includes a transport device, a drive device, and a filling device. The transport device has a plurality of transport belts that extend from the start region to the target region and are arranged at a distance from one another. The drive device is coupled to the transport belts and is designed to drive the transport belts, in particular adjacent ones of the transport belts, at different speeds, so that the components each lie between two adjacent ones of the transport belts, at least in the target region. The filling device deposits components in random orientations onto the transport belts in the start region. The present disclosure also relates to a method for aligning cylindrical components.

### CROSS-REFERENCE TO RELATED APPLICATIONS

This application claims priority under 35 U.S.C. § 119(a) to German Patent Application No. DE 10 2023 133 429.8, filed on Nov. 29, 2023, the entire disclosure of which is incorporated by reference.

### FIELD

The present disclosure relates to a transport apparatus for transporting cylindrical components, in particular battery cells. The disclosure also relates to a method for aligning cylindrical components, in particular battery cells.

### BACKGROUND

Especially in the field of battery production, it is necessary to align cylindrical components, specifically cylindrical battery cells, that are provided in random positions, for example as bulk material, with one another in order to insert them in the correct pole position into a housing of a larger battery, for example.

A simple and cost-effective solution is sought for aligning the battery cells. In addition, transport should be carried out gently, especially for sensitive components, in order to avoid damage.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

It is therefore an object of the present disclosure to provide a transport apparatus that realizes an alignment of cylindrical components, in particular battery cells, in a simple and cost-effective manner.

This object is achieved by an apparatus according to the principles of the present disclosure and by a method according to the principles of the present disclosure.

The present disclosure relates to an apparatus for transporting cylindrical components, in particular battery cells, from a start region to a target region. In one example, the apparatus includes a first transport device, a drive device, and a filling device. The first transport device has a plurality of transport belts that are arranged at a distance from one another and form a transport path from the start region to the target region. The drive device is coupled to the transport belts and is designed to drive the transport belts, in particular adjacent transport belts, at different speeds so that the components each lie between two adjacent transport belts, at least in the target region. The filling device deposits components in random orientations onto the transport belts in the start region.

Driving the transport belts at different speeds results in the components being rotated if they are still lying transversely on the transport belts. This rotation results in the components being aligned in the gap between two transport belts, at least in the target region. This solution only requires the transport belts to be driven at different speeds, which allows a simple and cost-effective solution.

The object is thus fully achieved.

In a preferred development, the transport belts extend from the start region to the end region. In other words, the transport belts each run along the entire transport path. The advantage of this design is its simple construction.

In an alternative development, the transport path between the start region and the end region is formed by a plurality of transport belts arranged one behind the other. The advantage of this solution is that the flexibility of the transport device can be increased. In this way, different speeds can also be achieved in the longitudinal direction, i.e., in the transport direction.

In a preferred development, the transport belts have a round cross section. This cross section has the advantage that it makes it easier to transfer the components into the gaps between the transport belts.

In a preferred development, the transport belts lie in one plane. This measure has also proven to be advantageous. Alternatively, however, the transport belts can also lie in different transport planes, preferably two transport planes, wherein the transport belts lie in one or the other transport plane alternately in pairs.

In a preferred development, the drive device has at least one gear unit that is designed to drive a first subgroup of transport belts at a first speed and a second subgroup of transport belts at a second speed, wherein transport belts of the first subgroup and transport belts of the second subgroup alternate. Alternatively, the different speeds of the transport belts can also be realized via a drive that drives pulleys with different diameters for the different speeds of the transport belts. Preferably, the speed decreases from outside to inside or from inside to outside, viewed transversely to the transport direction. More preferably, the speed of the respective transport belts changes alternately, viewed transversely to the transport direction.

Alternatively, the drive device has two drive motors, wherein one drive motor drives a first subgroup of transport belts at a first speed, and the other drive motor drives a second subgroup of transport belts at a second speed, wherein transport belts of the first subgroup and transport belts of the second subgroup alternate.

Both alternative measures allow cost-effective yet effective solutions for aligning the components to be realized.

In a preferred development, the distance between the transport belts is adjustable. For example, the distances can be adjusted individually, or alternatively in groups, or all together.

This measure has the advantage that the transport apparatus can be used very flexibly, since there can be a fast response to different sizes of the components.

In a preferred development, the transport belts have different surface properties, in particular different friction values. More preferably, the transport belts have different diameters.

These measures again improve the alignment of the components, in particular the rotation of the components, in order to guide them into the gap between two transport belts.

In a preferred development, the filling device has a hopper for receiving many components and has a conveyor belt, wherein the conveyor belt ends in the start region in order to deposit, for example pour, components onto the transport belts.

In a preferred development, a distribution device is provided, which is designed to displace components transversely to the transport direction. Further preferably, the distribution device has deflection elements that are provided between transport belts and are designed to displace components transversely to the transport direction in a controlled manner. The deflection elements are preferably designed as guide plates. The deflection elements can however also be provided in the form of air pulse generators, nozzles, magnetic field generating apparatuses. It would also be possible to provide one or more rollers that act on the transport belts or on the components. In this case, the rollers can be self-driven or passively rotating. Finally, it would also be possible to provide brushes, which can be applied from the side, from above or from below. The brushes can be designed such that electrostatic charge is discharged.

Further preferably, a control device is provided, which actuates the distribution device in such a way that the components are distributed transversely to the transport direction. The control unit preferably receives information from sensors, in particular optical sensors, such as camera systems with image processing and laser measuring devices, or ultrasonic sensors, radar sensors, etc. The distribution device is controlled depending on the data provided by the sensors.

These measures have the advantage that the components can be evenly distributed across all the gaps between transport belts. The deflection elements make it possible to guide an impacting component into an adjacent gap in a controlled manner. In order to prevent components from falling out of the transport apparatus to the side, lateral guide elements or limits are preferably provided.

In a preferred development, a holding device that is movable between at least two positions is provided in the target region and is designed, in the first position, to stop the components transported into the target region and, in the second position, to release these components for further transport. Further preferably, in the target region, the first transport device is followed by a second transport device for transporting workpiece carriers, such that components released by the holding device can be transferred into a workpiece carrier. Further preferably, the second transport device transports the workpiece carriers with the components into a transfer region in which a transfer device is provided and designed to receive the components from a workpiece carrier in a desired longitudinal orientation.

These measures have proven to be particularly advantageous. They allow the components, in this case in particular battery cells, to be received from the workpiece carriers with a desired pole position using simple means and, for example, to be transferred to a subsequent process.

The present disclosure also relates to a method for aligning cylindrical components, in particular battery cells. In one example, the method includes the following steps: depositing the components in a start region of a transport device that has a plurality of transport belts arranged at a distance from one another; transporting the components by means of the transport device to a target region; and rotating the components on the transport belts, so that each component lies completely between two adjacent transport belts, by driving adjacent transport belts at different speeds.

The advantages of this method correspond to the aforementioned advantages, and therefore a repetition can be dispensed with at this point.

It is understood that the features mentioned above and those to be explained below can be used not only in the combination specified in each case, but also in other combinations or on their own without departing from the scope of the present disclosure.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a schematic diagram of a transport apparatus;

FIG. 2a is a detail view of extract II of FIG. 1;

FIG. 2b is a schematic diagram of an alternative arrangement of transport belts;

FIG. 3 is a detail view of extract III of FIG. 1;

FIG. 4 is a detail view of extract IV of FIG. 1;

FIG. 5 is a detail view of extract V of FIG. 1;

FIG. 6 is a detail view of extract VI of FIG. 1;

FIG. 7 is a detail view of the transfer device from extract V of FIG. 1;

FIG. 8 is a schematic perspective diagram of the transport apparatus according to the disclosure; and

FIG. 9 is a schematic perspective diagram of a transport apparatus according to a further exemplary embodiment.

In the drawings, reference numbers may be reused to identify similar and/or identical elements.

### DETAILED DESCRIPTION

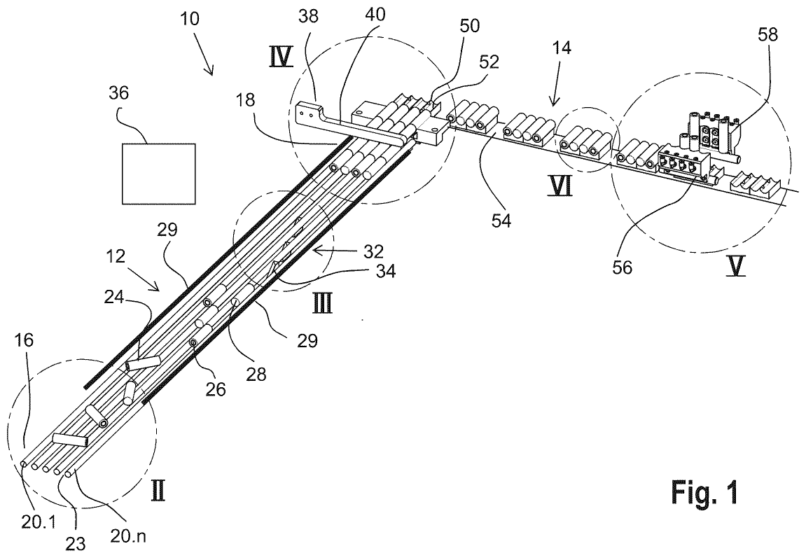

In FIG. 1, a transport apparatus is shown in a schematic diagram and identified with the reference sign 10. The transport apparatus 10 serves to transport cylindrical components, in particular battery cells 24 (hereinafter referred to as cells for short), to align them with one another and finally to receive them in a desired longitudinal orientation or polarity. Such a transport apparatus 10 is used, for example, in battery cell production to combine individual cells into a battery cell package. At this point it should be noted that the representation in the figures is purely schematic in nature and shows only the components necessary for understanding the disclosure.

The transport apparatus 10 has a first transport device 12 and a second transport device 14, wherein the second transport device 14 preferably extends at right angles to the first transport device 12. The two transport devices 12 and 14 are arranged relative to one another in such a way that a cell 24 can be transported from a start region 16 to a target region 18 of the first transport device 12 and from there to the second transport device 14. In other words, the cells 24 in the target region 18, i.e., at the end of the first transport device 12, are transferred to the second transport device 14.

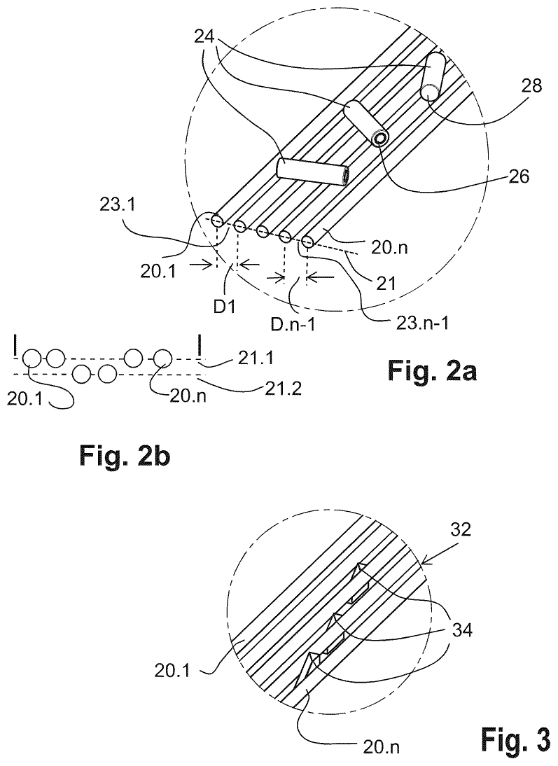

The first transport device 12 has a plurality of transport belts 20.1-20.n, which are arranged parallel to one another and preferably at equal distances D1 to D.n−1 (cf. FIG. 2a) and form tracks 23.1 to 23.n−1 between them. In the present exemplary embodiment, the transport belts 20.1-20.n lie in one transport plane 21. The transport belts 20 preferably have a round cross section, but may also have a different cross-sectional shape depending on the application. The transport belts 20 are designed as endless belts that are guided over rollers or pulleys (not shown). At least one of these rollers is driven by a drive, e.g. an electric motor-gear unit. The individual transport belts preferably extend over the entire length between the start region and the end region. Alternatively, a plurality of transport belts arranged one behind the other can also form the transport path between the start region and the end region.

As already mentioned, the distances between the transport belts 20, and thus the width of the tracks 23, are preferably equal, with the distance depending on the diameter of the cells 24. The distance is smaller than the diameter of the cells 24. At this point, however, it should be noted that the transport device 12 can be designed such that the distances between the individual transport belts 20 are adjustable either all together or individually. This allows the transport device 12 to be adapted to different cell sizes. This means that if cells 24 with a smaller diameter are used, the distances are reduced; if the diameters are larger, the distances are increased so that the width of the tracks 23 is always smaller than the diameter of the cells.

The transport belts 20 are driven so that the cells 24 lying on the transport belts move from the start region 16 to the target region 18. In order to prevent cells 24 from falling off the transport belts 20 to the side, the transport device 12 has lateral limits 29 that are arranged adjacently to the outer transport belts 20.1 and 20.n.

In FIG. 2a, portion II of FIG. 1 is shown again in an enlarged diagram. Clearly visible here are a total of five transport belts 20.1-20.5, which form four tracks 23, wherein the number n of transport belts and thus the number n-1 of tracks 23 is selected depending on the application. The number of transport belts depends substantially on how many tracks 23 or, in other words, adjacent cells 24 are to be transferred to the second transport device. For example, if m cells are to be transferred next to one another, m+1 transport belts must be provided. In the present exemplary embodiment, with five transport belts, four mutually adjacent cells can therefore be transferred in four tracks 23 to the second transport device.

As can also be seen in FIG. 2a, the cells 24 are deposited in random longitudinal orientations onto the transport belts 20. In other words, the longitudinal axes of the cells 24 are not parallel to the transport belts 20. However, these cells 24 are to be aligned during transport so that their longitudinal axes are parallel to the transport belts 20, which means that the cells 24 are to be guided into the tracks 23. The cells must therefore be rotated about an axis perpendicular to the transport plane during transport.

This rotation and thus also transfer into a track 23 is achieved according to the disclosure in that the transport belts 20.1 to 20.n are moved at different speeds. For example, adjacent transport belts 20 are moved at different speeds. In a preferred embodiment, for example, the transport belts 20.1, 20.3, 20.n are moved at a first speed v1, while the transport belts 20.2 and 20.n−1 are moved at a second speed v2, wherein v1 is greater or smaller than but not equal to v2. Due to the different speeds of adjacent transport belts 20, a torque acts on the cells 24 (unless they are already lying parallel to the transport belts in a track 23), which torque causes rotation. With a corresponding length of the transport path, the cells 24 are aligned during transport and guided into the tracks 23 so that they are all parallel to the transport belts, i.e., between two adjacent transport belts, at least in the target region 18.

In order to ensure that the cells 24 are evenly distributed over the width of the first transport device 12, i.e., all tracks are occupied by cells in the target region 18, a distribution device 32 is provided, which has deflection elements 34 that can be moved via actuators. These deflection elements are each located between two adjacent transport belts, i.e., in a track 23, and can be moved via actuators upward into the track 23, i.e., into the movement path of the cells. By means of the deflection elements 34, a cell 24 can be moved into the adjacent track 23. In order to achieve a uniform distribution of the cells over all the tracks 23.1 to 23.n−1 via this distribution device 32, a controller 36 is required, which, for example, receives images from a camera, from which images the distribution of the cells 24 can be determined using appropriate software.

At this point, it should be noted that the controller 36 can preferably also adjust the speed of the transport belts 20, so that the orientation of the cells can be influenced by reducing or increasing the differential speed (v1-v2) of the transport belts. The transfer of the cells into the tracks 23 can also be influenced by appropriately selecting the materials of the transport belts 20, in particular their friction factors.

Furthermore, it is also possible, as shown in FIG. 2b, to arrange the transport belts 20.1 to 20.n in different planes 21.1, 21.2. For example, pairs of transport belts can be arranged alternately in a first transport plane 21.1 and a second transport plane 21.2.

The distribution device 32 is shown more clearly in the detail diagram in FIG. 3. Here, in particular, the deflection elements 34 can be seen, which can be moved upward between two adjacent transport belts, i.e., into a track 23. In particular, the deflection elements 34 have an inclined flank onto which the cell 24 impacts and is thereby guided into the adjacent track. Although only three deflection elements 34 are shown in FIG. 3, deflection elements 34 are preferably provided for each track 23 of the transport device 12. The deflection elements 34 can also be used to block certain tracks. For example, if the transport device has more tracks than required, outer tracks in particular can be blocked and consequently closed.

A holding device 38 is provided at the end of the first transport device 12 in the target region 18, and has a bar-like element 40. This bar-like element 40 extends transversely across the transport device 12, i.e., across the transport belts 20.1-20.n. The element 40 is provided to align the cells lying in the plurality of tracks 23 with one another by acting like a stop for the cells when in its lower position. If the element 40 is moved upward, for example, the cells in the tracks 23 are released and can be transported and transferred in the direction of the second transport device 14.

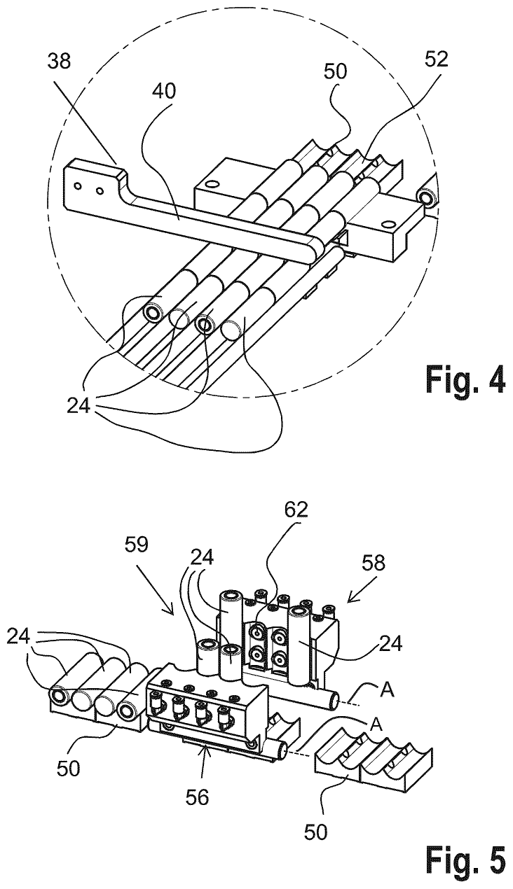

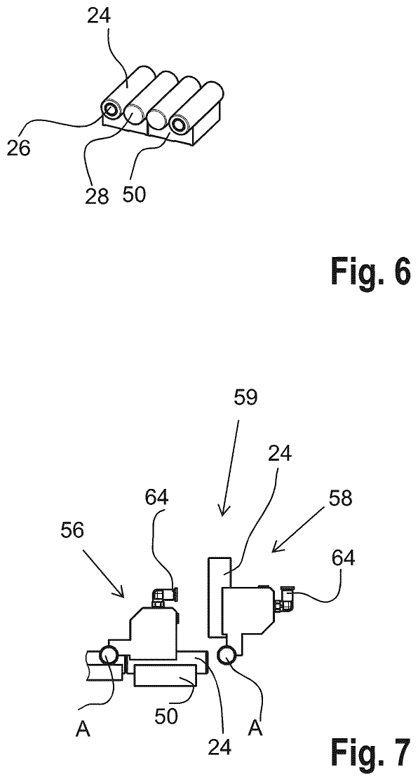

In FIG. 4, this transfer region is shown again in detail. It can be clearly seen that the cells 24 lying in the tracks 23 are aligned with one another so that they can be transferred, for example, onto a workpiece carrier 50 and into partially cylindrical receptacles 52 there. The workpiece carrier 50 lies on a transport belt 54 of the second transport device 14, as shown in FIG. 1.

In the present case, four cells 24 on a workpiece carrier 50 are transported further into a receiving region in which two handling elements 56, 58 of a transfer device 59 are provided. These handling elements 56, 58, shown in detail in FIG. 5, serve to pick up the cells from a workpiece carrier 50 for further processing, in such a way that the cells 24 have a predetermined polarity orientation. The polarity orientation can be selected as desired. In the present exemplary embodiment, the four cells 24 are held on the workpiece carrier 50 such that the positive poles 26 point upward. This can be achieved, for example, by the handling element 58 gripping the cells with the positive pole on one side of the workpiece carrier 50, and the other handling element 56 gripping the cells with the positive pole on the other opposite side. At this point, it should be noted that the two handling elements 56, 58 do not necessarily only pick up cells of the same polarity orientation, as shown in FIG. 5. The selection of cells can be chosen as desired.

The handling elements 56, 58 can be part of a larger handling apparatus, e.g. a robot, which inserts the cells, now also with aligned polarity, into a larger battery pack, for example.

As can be seen in FIGS. 5 and 7, the two handling elements 56, 58 have suction elements 62 that are connected to hose couplings 64, to each of which a hose can be connected to generate a vacuum in the region of the suction elements 62.

The two handling elements 56, 58 can each be rotated or pivoted about a rotation axis A so that they can grip the horizontally positioned cells on the workpiece carrier and move them into the vertical position.

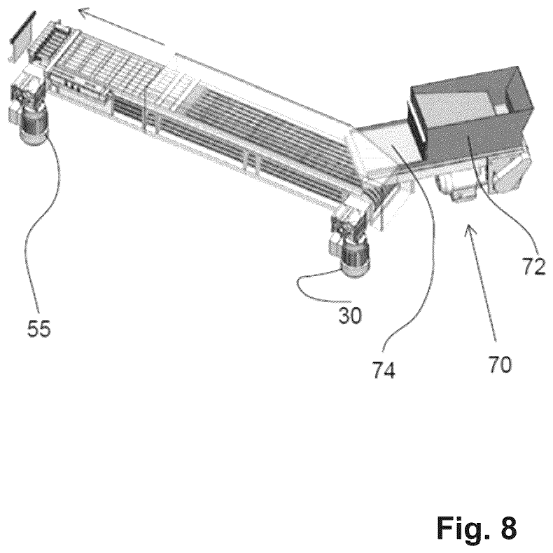

In FIG. 8, a portion of the transport apparatus 10, in particular the first transport device 12, is shown in a perspective diagram. The first transport device 12 has an electric drive 30, preferably a motor-gear unit, which drives the transport belts at the different speeds. The different speeds of the transport belts can be achieved by means of different gear ratios or by using servo or frequency converter technology. Alternatively, drive pulleys with different diameters can also be used for each transport belt or for groups of transport belts.

The transport belt 54 of the second transport device 14 is driven by a motor 55, which can be seen in FIG. 8. This motor moves the transport belt 54 in a timed manner such that the transport belt stops until the cells are transferred to a workpiece carrier 50 and the cells are picked up by the handling elements, and is then moved by one “step length” to bring the next workpiece carrier into the transfer region.

FIG. 8 also shows a filling device 70, which has a hopper 72 that is assigned to a conveyor belt 74. Cells are poured randomly into the hopper 72 and then pass via the conveyor belt 74 to the transport belts 20 in the start region 16. The cells 24 therefore arrive onto the transport belts in a random state.

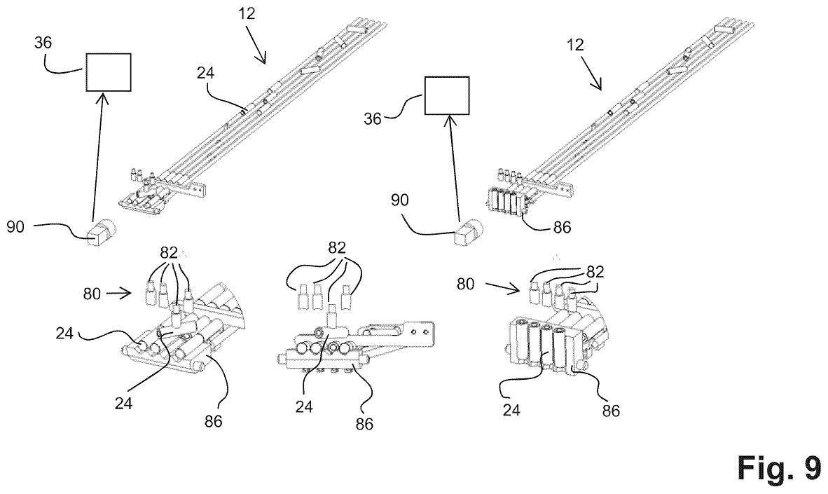

FIG. 9 shows an alternative transport apparatus 10′, the structure of which substantially corresponds to the structure of the previously described transport apparatus 10, and therefore only the differences will be discussed below.

The transport apparatus 10′ does not have a second transport device that transports the cells 24 directly out of the end region. Instead, a handling device 80 is provided in the target region, which handling device has a plurality of gripping elements 82, e.g. vacuum gripping elements, which are designed to grip and rotate one cell 24 each in order to achieve a desired pole position of the cell. The cells 24 lie on a support device 86, which can be tilted 900 about a horizontal axis. The cells 24 on the support device 86 can thus be brought into an upright position in which they can then be transported further, for example via a second transport device 14.

To detect the pole position of the cells 24 on the support device, an optical sensor is provided, e.g. an optical camera system 90 with image processing, which transmits corresponding information to the controller 36. The controller 36 then actuates the corresponding gripping elements 82 to lift the desired cells 24 from the support device 86, rotate them 180° and place them back onto the support device 86.

The transport apparatus 10 or 10′ makes it possible to deposit cells 24 randomly onto transport belts and then to align them during transport from a start region to a target region and to guide them into the tracks defined between the transport belts. By means of the deflection elements, the individual tracks can also be filled evenly so that there is one cell in each track in the target region. These mutually adjacent cells are then transferred to a workpiece carrier and transported in a timed manner to a pickup region. In this pickup region, the cells are picked up in a controlled manner by two handling elements so that the cells can be guided to a downstream process in a desired pole position.

By means of the transport apparatus 10 consisting of the two transport devices 12 and 14, randomly deposited cells 24 can therefore be aligned in a simple and cost-effective manner, transferred to workpiece carriers 50 and also picked up in an ordered manner with regard to polarity and further processed.

What is claimed is:

1. An apparatus for transporting cylindrical components from a start region to a target region, the apparatus comprising:
a first transport device having a plurality of transport belts that are arranged at a distance from one another and form a transport path from the start region to the target region;
a drive device that is coupled to the transport belts and is designed to drive the transport belts at different speeds so that the components each lie between two adjacent ones of the transport belts, at least in the target region; and
a filling device that deposits the components in random orientations onto the transport belts in the start region.

2. The apparatus according to claim 1, wherein the transport belts extend from the start region to the target region.

3. The apparatus according to claim 1, wherein the transport path between the start region and the target region is formed by multiple ones of the transport belts arranged one behind the other.

4. The apparatus according to claim 1, wherein the transport belts have a round cross section.

5. The apparatus according to claim 1, wherein the transport belts lie in one transport plane.

6. The apparatus according to claim 1, wherein adjacent ones of the transport belts are arranged at different heights, at least in some portions.

7. The apparatus according to claim 1, wherein the transport belts lie in two transport planes, wherein the transport belts lie in one or the other of the two transport planes alternately in pairs.

8. The apparatus according to claim 1, wherein the drive device has at least one gear unit that is designed to drive a first subgroup of the transport belts at a first speed and a second subgroup of the transport belts at a second speed, wherein the transport belts of the first subgroup and the transport belts of the second subgroup alternate.

9. The apparatus according to claim 1, wherein the drive device has two drive motors, wherein one drive motor drives a first subgroup of the transport belts at a first speed, and the other drive motor drives a second subgroup of the transport belts at a second speed, wherein the transport belts of the first subgroup and the transport belts of the second subgroup alternate.

10. The apparatus according to claim 1, wherein the distance between the transport belts is adjustable.

11. The apparatus according to claim 1, wherein the transport belts have different surface properties.

12. The apparatus according to claim 11, wherein adjacent ones of the transport belts have different friction values.

13. The apparatus according to claim 1, wherein the transport belts have different diameters.

14. The apparatus according to claim 1, wherein the filling device has a hopper for receiving many components and has a conveyor belt, wherein the conveyor belt ends in the start region in order to deposit components onto the transport belts.

15. The apparatus according to claim 1, further comprising:
a distribution device that is designed to displace the components transversely to the transport direction, wherein the distribution device has deflection elements that are provided between the transport belts and are designed to displace the components transversely to the transport direction in a controlled manner, wherein the deflection elements are designed as one of a guide plate or an air pulse generator; and
a controller that actuates the distribution device such that the components are distributed transversely to the transport direction.

16. The apparatus according to claim 1, further comprising a holding device that is movable between at least two positions, is provided in the target region and is designed, in the first position, to stop the components transported into the target region and, in the second position, to release these components for further transport.

17. The apparatus according to claim 16, further comprising a second transport device for transporting workpiece carriers, wherein, in the target region, the first transport device is followed by the second transport device such that components released by the holding device can be transferred into one of the workpiece carriers.

18. The apparatus according to claim 17, further comprising a transfer device provided in a transfer region, wherein the second transport device transports the workpiece carriers with the components into the transfer region, wherein the transfer device is designed to grip the components lying on one of the workpiece carriers and to pass them on in a predeterminable orientation.

19. An apparatus for transporting cylindrical components from a start region to a target region, the apparatus comprising:
a first transport device having a plurality of transport belts that are arranged at a distance from one another and form a transport path from the start region to the target region;
a drive device that is coupled to the transport belts and is designed to drive the transport belts so that the components each lie between two adjacent ones of the transport belts, at least in the target region; and
a filling device that deposits the components in random orientations onto the transport belts in the start region.

20. A method for aligning cylindrical components, the method comprising:
depositing the components in a start region of a transport device that has a plurality of transport belts arranged at a distance from one another;
transporting the components to a target region using the transport device; and
rotating the components on the transport belts, so that each component lies completely between two adjacent ones of the transport belts, by driving adjacent ones of the transport belts at different speeds.
